(19) United States
(12) Patent Application Publication
(10) Pub. No.: US 2007/0136717 A1
(43) Pub. Date: Jun. 14, 2007

(54) List creating apparatus

(76) Inventor: Masaaki Ueda, Osaka (JP)

Correspondence Address: Gerald T. Bodner, Esq.;BODNER & O'ROURKE, LLP, 425 Broadhollow Road, Suite 108, Melville, NY, 11747, US

(21) Appl. No.: 11/602,030

(22) Filed: Nov. 20, 2006

(30) Foreign Application Priority Data
Nov. 22, 2005 (JP) 2005-336797

(51) Int. Cl. G06F 9/44

(52) U.S. Cl. 717/106

(57) ABSTRACT

A list creating apparatus includes a CPU. A superior directory which manages a plurality of subordinate directories is stored in a plurality of clusters formed in a recording medium. The CPU designates in turn each of the plurality of clusters, and designates in turn a plurality of sectors forming the designated cluster. The CPU also determines whether or not the designated cluster is an end cluster, and further determines whether or not the designated sector is an end sector. The data stored in the designated cluster is read when the determination result as to the designated cluster is negative. The data stored in the designated sector is read when the determination result as to the designated cluster is affirmative, and the determination result as to the designated sector is negative. A subordinate directory name included in the read data is added to a directory list.

### CROSS REFERENCE OF RELATED APPLICATION

The disclosure of Japanese Patent Application No. 2005-336797 is incorporated herein by reference.

### BACKGROUND OF THE INVENTION

1. Field of the Invention

The present invention relates to a list creating apparatus. More specifically, the present invention relates to a list creating apparatus to create a list of a plurality of items stored in a storage location.

2. Description of the Related Art

An example of this kind of an apparatus is disclosed in the Document 1 (Japanese Patent Laying-open No. 2002-342139). According to the Document 1, when a recording starting operation or a reproduction starting operation is performed, names of all the directories (items) recorded in a hard disk are detected, and the detected names are registered in a table. The recording process or reproduction process is executed with reference to the directory list (item list) thus created.

If the hard disk manages a plurality of directories in an FAT system, these directories are recorded in a plurality of clusters in a distributed manner. Furthermore, in the FAT system, each of the clusters is formed by a plurality of sectors. As a method of detecting a directory name from the hard disk, conceivable are a method (1) of reading directory information for each sector and a method (2) of reading directory information for each cluster.

However, in the method (1), in a case that a multiplicity of directories exist in the hard disk, frequent accesses to the hard disk occur. Furthermore, in a case that a multiplicity of files exist in the hard disk, more frequent accesses to the hard disk than that in the method (2) occur. On the other hand, in the method (2), in a case that a plurality of directories are respectively stored in a plurality of clusters, and each directory is smaller in size than each cluster, useless reading processing occurs. Accordingly, in adopting any of these methods (1) and (2), creating the directory list may take a lot of time.

### SUMMARY OF THE INVENTION

Therefore, it is a primary object of the present invention to provide a novel list creating apparatus.

Another object of the present invention is to provide a list creating apparatus capable of shortening a time required to create an item list.

A data readout apparatus (10: reference numeral designating a portion corresponding in the embodiments. This holds true for the following) according to the present invention claim 1 comprises a first unit area designator (S81, S91, S131, S141) for designating in turn each of one or more first unit areas storing a superior item which manages a plurality of subordinate items; a second unit area designator (S93, S103, S143, S153) for designating in turn each of a plurality of second unit areas which forms the first unit area designated by the first unit area designator; a first unit area determiner (S85, S135) for determining whether or not the first unit area designated by the first unit area designator is an end first unit area; a second unit area determiner (S101, S151) for determining whether or not the second unit area designated by the second unit area designator is an end second unit area; a first reader (S87, S137) for reading superior item data from the first unit area designated by the first unit area designator when the determination result by the first unit area determiner is negative; a second reader (S95, S145) for reading another superior item data from the second unit area designated by the second unit area designator when the determination result by the first unit area determiner is affirmative, and the determination result by the second unit area determiner is negative; and a creator (S121, S173) for creating a subordinate item list on the basis of the superior item data read by each of the first reader and the second reader.

Each of one or more first unit areas storing a superior item which manages a plurality of subordinate items is designated in turn by a first unit area designator. Furthermore, each of a plurality of second unit areas which forms the first unit area designated by the first unit area designator is designated in turn by a second unit area designator. A first unit area determiner determines whether or not the first unit area designated by the first unit area designator is an end first unit area. Also, a second unit area determiner determines whether or not the second unit area designated by the second unit area designator is an end second unit area.

The superior item data in the first unit area designated by the first unit area designator is read by a first reader when the determination result by the first unit area determiner is negative. Another superior item data in the second unit area designated by the second unit area designator is read by a second reader when the determination result by the first unit area determiner is affirmative, and the determination result by the second unit area determiner is negative. The creator creates a subordinate item list on the basis of the superior item data read by each of the first reader and the second reader.

Accordingly, if the first unit area designated by the first unit area designator is a first unit area prior to an end first unit area, the superior item data in the first unit area is read by the first reader. The first unit area designator designates in turn each of the plurality of noticed first unit areas, and therefore, the first reader reads in turn the superior item data stored in the first unit area prior to the end first unit area.

The superior item data of the second unit area is read by the second reader if the first unit area designated by the first unit area designator is an end first unit area, and the second unit area designated by the second unit area designator is a second unit area prior to an end second unit area. The second unit area designator also designates in turn each of the plurality of noticed second unit areas, and therefore, the second reader reads in turn the superior item data stored in the second unit area prior to the end second unit area.

That is, until the end first unit area is detected, the superior item data is read for each first unit area. When the end first unit area is detected, the superior item data is read for each second unit area. This reduces frequent access operations and prevents useless data reading processing from being performed, capable of shortening a time required to create a directory list DL.

A list creating apparatus according to claim 2 is dependent on claim 1, and further comprises a detector (S115, S125, S165, S177) for detecting an end of the superior item on the basis of the superior item data read by the second reader; and a finisher (S99, S149) for finishing the creating process by the creator in response to the detection of the detector. This makes it possible to further shorten the time required to create the subordinate item list.

A list creating apparatus according to claim 3 is dependent on claim 1 or 2, and the first unit areas are discretely distributed on a recording medium (32) and managed by an arrangement management table (FAT 1, FAT 2), and the first unit area determiner performs a determination operation with reference to the arrangement management table.

A list creating apparatus according to claim 4 is dependent on any one of claims 1 to 3, and the second unit areas are successive in each first unit area, the number of second unit areas belonging to each first unit area is fixed, and the second unit area determiner performs a determination operation by counting the number of second unit areas designated by the second unit area designator.

A list creating apparatus according to claim 5 is dependent on any one of claims 1 to 4, and the first unit area corresponds to a cluster, the second unit area corresponds to a sector, and the item corresponds to a directory or a file.

According to claim 6, a list creating program executed by a processor (38) of a list creating apparatus (10) comprises a first unit area designating step (S81, S91, S131, S141) for designating in turn each of one or more first unit areas storing a superior item which manages a plurality of subordinate items; a second unit area designating step (S93, S103, S143, S153) for designating in turn each of a plurality of second unit areas which forms the first unit area designated by the first unit area designating step; a first unit area determining step (S85, S135) for determining whether or not the first unit area designated by the first unit area designating step is an end first unit area; a second unit area determining step (S101, S151) for determining whether or not the second unit area designated by the second unit area designating step is an end second unit area; a first reading step (S87, S137) for reading superior item data from the first unit area designated by the first unit area designating step when the determination result by the first unit area determining step is negative; a second reading step (S95, S145) for reading another superior item data from the second unit area designated by the second unit area designating step when the determination result by the first unit area determining step is affirmative, and the determination result by the second unit area determining step is negative; and a creating step (S121, S173) for creating a subordinate item list on the basis of the superior item data read by each of the first reading step and the second reading step.

Similarly to claim 1, it is possible to shorten the time required to create the subordinate item list.

A list creating method according to claim 7, comprises the steps of: (a) designating in turn each of one or more first unit areas storing a superior item which manages a plurality of subordinate items; (b) designating in turn each of a plurality of second unit areas which forms the first unit area designated by the step (a); (c) determining whether or not the first unit area designated by the step (a) is an end first unit area; (d) determining whether or not the second unit area designated by the step (b) is an end second unit area; (e) reading superior item data from the first unit area designated by the step (a) when the determination result by the step (c) is negative; (f) reading another superior item data from the second unit area designated by the step (b) when the determination result by the step (c) is affirmative, and the determination result by step (d) is negative; and (g) creating an item list on the basis of the superior item data read by each of the step (e) and the step (f).

Similarly to claim 1, it is possible to shorten the time required to create the subordinate item list.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of a mapping state of an SDRAM applied to FIG. 1 embodiment;

FIG. 3 is an illustrative view showing one example of a mapping state of a recording medium applied to FIG. 1 embodiment;

FIG. 4 is an illustrative view showing a part of a directory structure recorded in the recording medium applied to FIG. 1 embodiment;

FIG. 5 is an illustrative view showing another part of the directory structure recorded in the recording medium applied to FIG. 1 embodiment;

FIG. 6 is an illustrative view showing a part of an FAT structure stored in the recording medium applied to FIG. 1 embodiment;

FIG. 7 is an illustrative view showing one example of a directory list applied to FIG. 1 embodiment;

FIG. 8 is an illustrative view showing one example of a file list applied to FIG. 1 embodiment;

FIG. 9 is an illustrative view showing another example of the file list applied to FIG. 1 embodiment;

FIG. 10 is a flowchart showing a part of an operation of the CPU applied to FIG. 1 embodiment;

FIG. 11 is a flowchart showing another part of the operation of the CPU applied to FIG. 1 embodiment;

FIG. 12 is a flowchart showing the other part of the operation of the CPU applied to FIG. 1 embodiment;

FIG. 13 is a flowchart showing a further part of the operation of the CPU applied to FIG. 1 embodiment;

FIG. 14 is a flowchart showing another part of the operation of the CPU applied to FIG. 1 embodiment;

FIG. 15 is a flowchart showing the other part of the operation of the CPU applied to FIG. 1 embodiment;

FIG. 16 is a flowchart showing a further part of the operation of the CPU applied to FIG. 1 embodiment; and

FIG. 17 is a flowchart showing another part of the operation of the CPU applied to FIG. 1 embodiment.

### DETAILED DESCRIPTION OF THE PREFERRED EMBODIMENTS

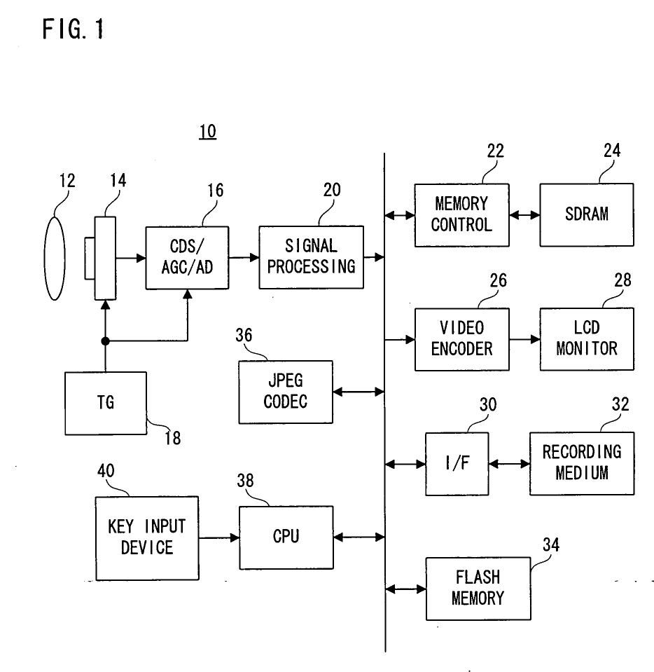

Referring to FIG. 1, a digital camera 10 of this embodiment includes an optical lens 12. An optical image of an object scene is irradiated to an imaging surface of an image sensor 14 through the optical lens 12, and subjected to a photoelectronic conversion. Thus, a raw image signal representing the object scene is generated.

If a camera mode is selected and a shooting operation is performed by a key input device 40, shooting processing is executed. A CPU38 instructs a TG (Timing Generator) 18 to perform a primary exposure. The TG18 performs a primary exposure on the image sensor 14, and reads a raw image signal thus generated in a raster scan manner from the image sensor 14. A CDS/AGC/AD circuit 16 performs a series of processes like a correlative double sampling, an automatic gain adjustment, and an A/D conversion on the raw image signal output from the image sensor 14 to output raw image data being a digital signal.

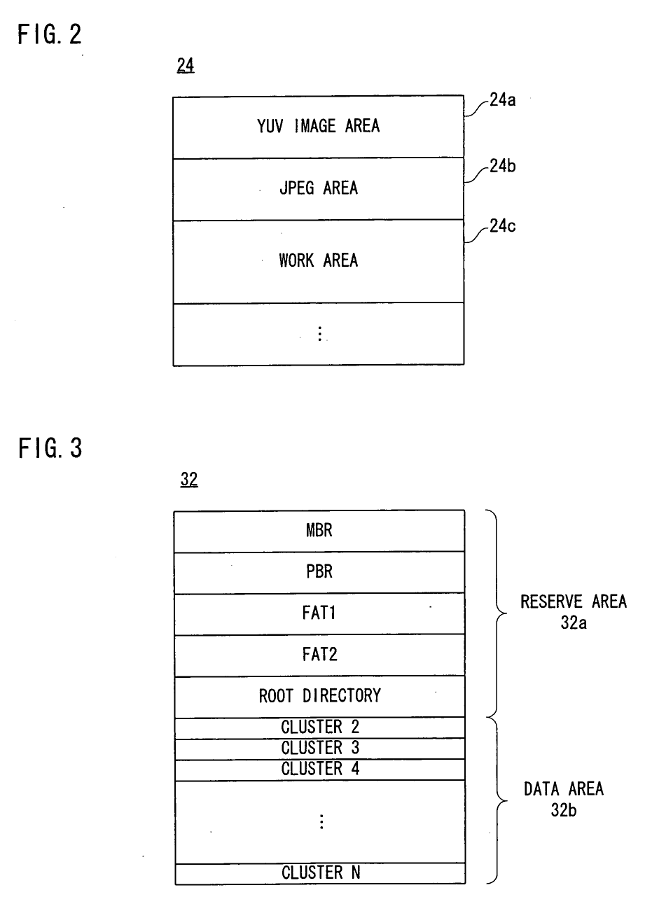

The raw image data is subjected to processes like a white balance adjustment, a color separation, a YUV conversion, etc. by a signal processing circuit 20. The image data in a YUV format thus obtained is written to an SDRAM 24 by a memory control circuit 22. Referring to FIG. 2, the SDRAM 24 has a YUV image area 24a, a JPEG area 24b, and a work area 24c . . . . The image data output from the signal processing circuit 20 is written to the YUV image area 24a.

A JPEG codec 36 reads the image data retained in the YUV image area 24a through the memory control circuit 22, compresses the read image data according to a JPEG system, and writes the compressed image data, that is, the JPEG data to the JPEG area 24b of the SDRAM 24 through the memory control circuit 22. The object scene image at a time when the shooting operation is performed is retained as JPEG data in the JPEG area 24b by execution of the above-described shooting processing.

The CPU38 reads the JPEG data stored in the JPEG area 24b through the memory control circuit 24, and records a JPEG file including the read JPEG data onto a recording medium 32 through an I/F 30.

When a reproduction mode is selected by the key input device 40, reproduction processing of the desired JPEG file is executed. The CPU38 accesses the recording medium 32 through the I/F 30 to read the JPEG data stored in the desired JPEG file. The read JPEG data is written to the JPEG area 24b of the SDRAM 24 through the memory control circuit 22.

The JPEG codec 36 reads the JPEG data from the JPEG area 24b through the memory control circuit 22, expands the read JPEG data, and writes the expanded. image data to the YUV image area 24a of the SDRAM 24 through the memory control circuit 22.

The video encoder 26 reads the image data stored in the YUV image area 24a through the memory control circuit 22, converts the read image data into a composite video signal in an NTSC system, and outputs the converted composite video signal to an LCD monitor 28. Consequently, a reproduced image is displayed on the monitor screen.

When an updating operation is performed by the key input device 40, the reproduction process is executed on another JPEG file. Thus, the reproduced image displayed on the monitor screen is updated with another reproduced image.

Referring to FIG. 3, the recording medium 32 is an MS-DOS formatted memory card. A reserve area 32a has an MBR (Master Boot Area), a PBR (Partition Boot Area), an FAT (File Allocation Table) 1, an FAT 2 being a copy of the FAT 1, and a root directory. A data area 32b is made up of a plurality of clusters, and each cluster is formed by 32 sectors. Also, an identification number (cluster number) starting from “2” is assigned to each of the clusters.

Here, the size of each sector is 512 bytes, and the size of each cluster is 16384 bytes. In addition, the size of the DE block (DE: Directory Entry) in which directory information or file information is described is 32 bytes.

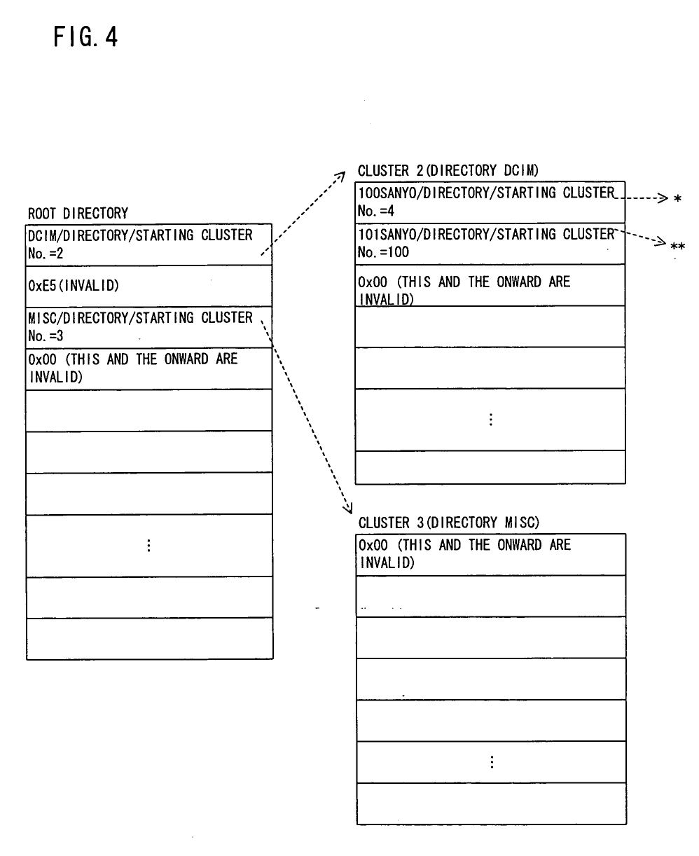

Referring to FIG. 4, in the first DE block of the root directory, a directory name “DCIM”, an attribute “directory” and a starting cluster number “2” are described as the directory information. In the second DE block, “0xE5” indicating that this is an invalid block is described. In the third DE block, the directory name “MISC”, the attribute “directory” and the starting cluster number “3” are described as the directory information. In the fourth DE block, “0x00” indicating that this and the onward are invalid blocks is described.

In the first DE block of the cluster 2, the directory name “100SANYO”, the attribute “directory” and the starting cluster number “4” are described as the directory information. In the second DE block, the directory name “101SANYO”, the attribute “directory”, and the starting cluster number “100” are described as the directory information. Furthermore, in the first DE block of the cluster 3, “0x00” indicating that this and the onward are invalid blocks is described.

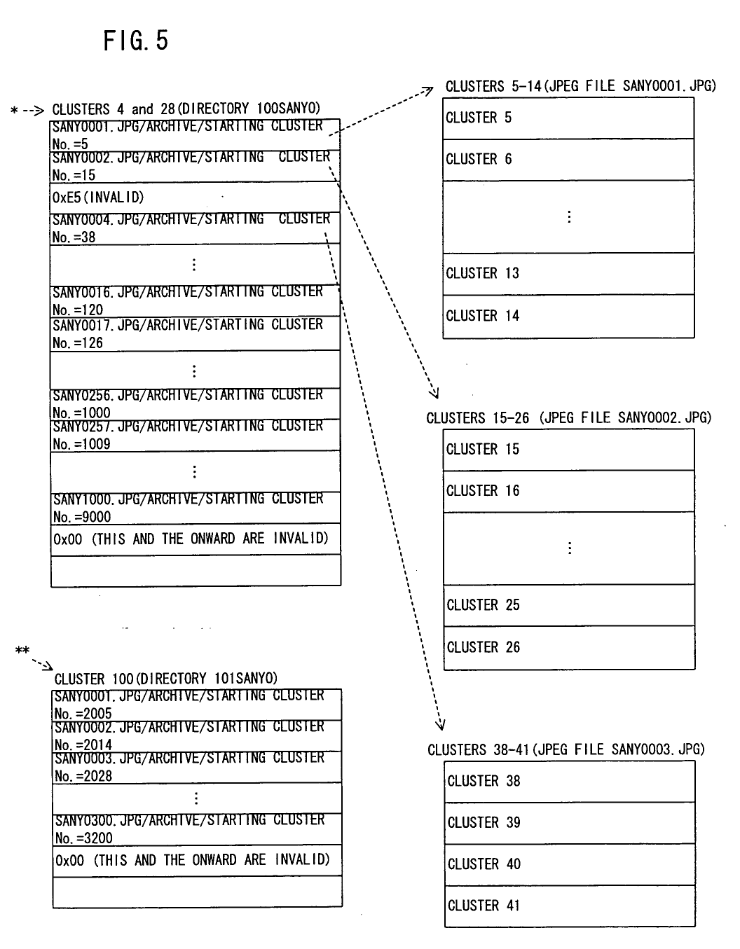

Referring to FIG. 5, in the first DE block of the cluster 4, the filename “SANY0001.JPG”, the attribute “archive”, and the starting cluster number “5” are described as the file information. In the second DE block, the filename “SANY0002.JPG”, the attribute “archive” and the starting cluster number “15” are described as the file information. In the third DE block, “0xE5” indicating that this is an invalid block is described. Successively, a plurality of DE blocks having a similar description is successively formed by bridging the clusters 4 and 28 over. In the cluster 100, a plurality of DE blocks having a similar description are formed.

The JPEG file “SANY0001.JPG” is stored so as to bridge the clusters 5-14, the JPEG file “SANY0002.JPG” is stored so as to bridge the clusters 15-26, and the JPEG file “SANY0004.JPG” is stored so as to bridge the clusters 38-41. Other JPEG files are stored so as to bridge a plurality of clusters in a similar manner. It should be noted that continuity of the data is assured within one cluster. That is, the data is continuously stored in 32 sectors forming each of the clusters.

As understood from the structure of the DE blocks shown in FIG. 4 and FIG. 5, the directory “DCIM” is stored in the cluster 2, and the directory “MISC” is stored in the cluster 3. In addition, directories “100SANYO” and “101SANYO” exist in the hierarchical sequence below the directory “DCIM”, and the directory “100SANYO” is stored in the clusters 4 and 28 while the directory “101SANYO” is stored in the cluster 100.

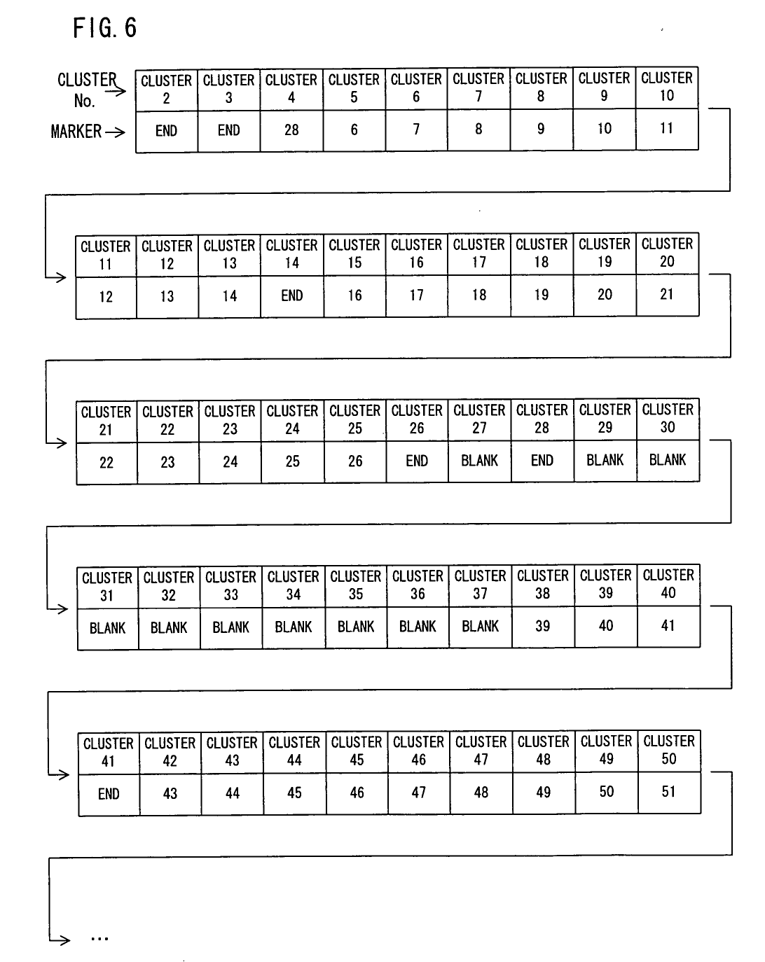

A link-state of a plurality of clusters related with each other are managed by the FAT 1 and the FAT 2 as shown in FIG. 6. Referring to FIG. 6, the marker indicative of “end” is assigned to the clusters 2, 3, 14, 26, 28, and 41. Furthermore, the marker indicative of “blank” is assigned to the clusters 27 and 29-37. Other clusters have markers indicative of identification numbers of the clusters storing data successive to the data the respective clusters store.

By referring to such the FAT 1 or FAT 2, it is understood that the directory “100SANYO” is stored in the cluster 28 other than the cluster 4, the JPEG file “SANY0001.JPG” is stored in the clusters 5-14, the JPEG file “SANY0002.JPG” is stored in the clusters 15-26, and the JPEG file “SANY0003.JPG” is stored in the clusters 38-41.

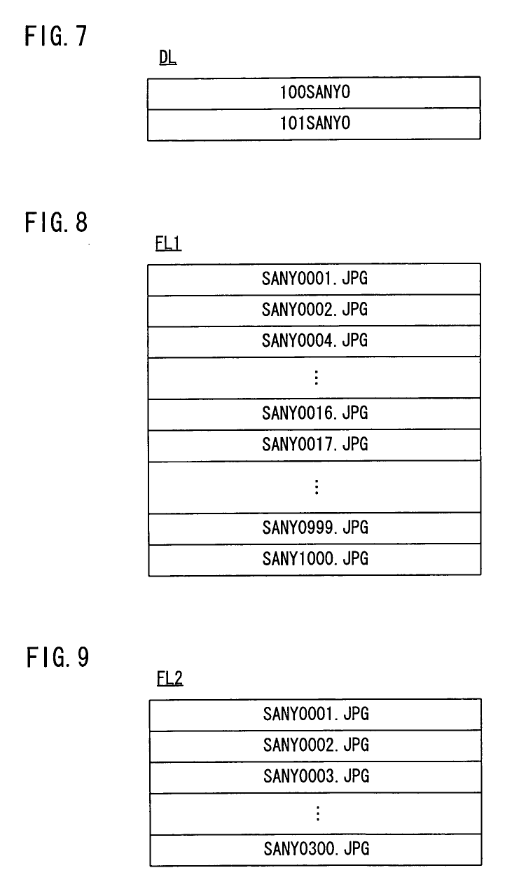

When a camera mode or a reproduction mode is selected, the directory names “100SANYO” and “101SANYO” described in the directory “DCIM” are first detected from the cluster 2. The detected directory names are written to the work area 24c of the SDRAM 24. Thus, a directory list DL shown in FIG. 7 can be obtained on the work area 24c.

When the camera mode is selected, a filename described in any one of the directories listed in the directory list DL is read. When the directory “100SANYO” is designated, the filename described in it is detected from the clusters 4 and 28. When the directory “101SANYO” is designated, the filename described in it is detected from the cluster 100. The detected filename is written to the work area 24c of the SDRAM 24, and the file list FL1 shown in FIG. 8 or the file list FL2 shown in FIG. 9 is thus obtained.

When the reproduction mode is selected, both of the file lists FL1 and FL2 are obtained on the work area 24c by noting both of the directories “100SANYO” and “101SANYO” described in the directory list DL.

The JPEG file created by shooting processing in the camera mode is written so as to bridge a plurality of clusters in a blank state, and the file information of the JPEG file is described in the DE block in the hierarchical sequence below the designated directory. In addition, each of the FAT 1 and FAT 2 is updated such that a link is established between the plurality of clusters storing the novel JPEG file.

It should be noted that the number of JPEG files manageable by each of the directories is “1000”. Accordingly, if the designated directory is full, another directory is created. The file information of the JPEG file created in the camera mode is described in the DE block in the hierarchical sequence below the novel directory.

In the reproduction mode, a desired JPEG file is selected by an updating operation utilizing the key input device 40. The cluster storing the selected JPEG file is specified with reference to the FAT 1 or the FAT 2. In the reproduction mode, by a delete operation utilizing the key input device 40, the currently reproduced JPEG file is deleted. More specifically, the file information of the noticed JPEG file is deleted from the directory, and corresponding markers are updated with “blank” on the FAT 1 and the FAT 2.

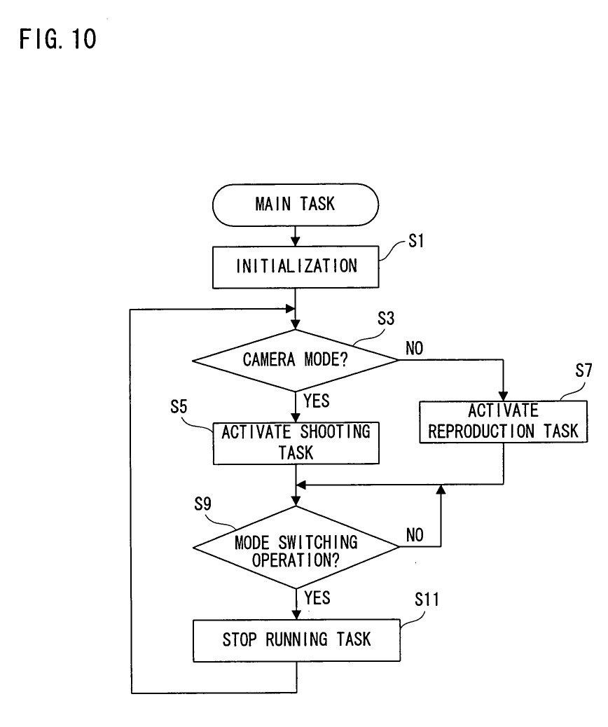

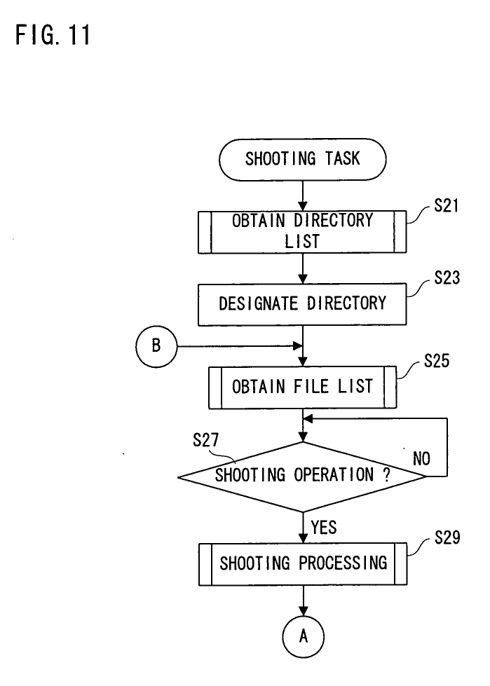

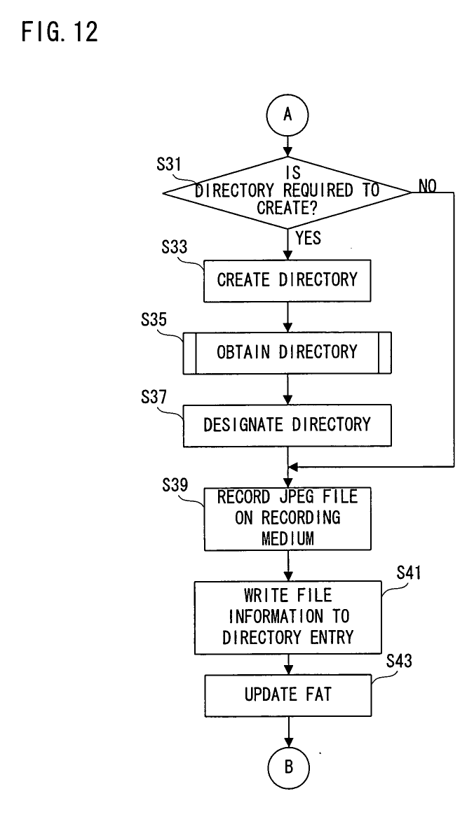

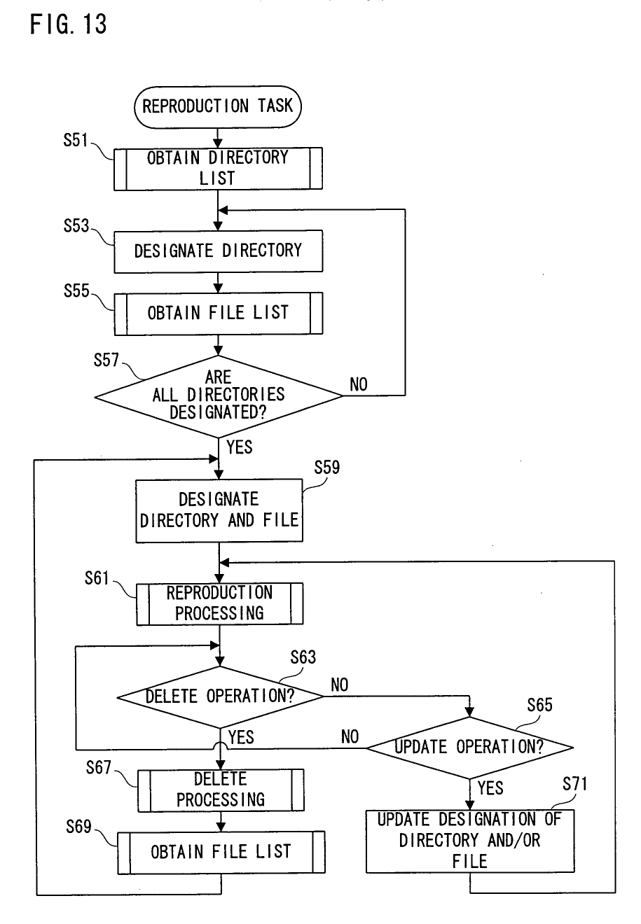

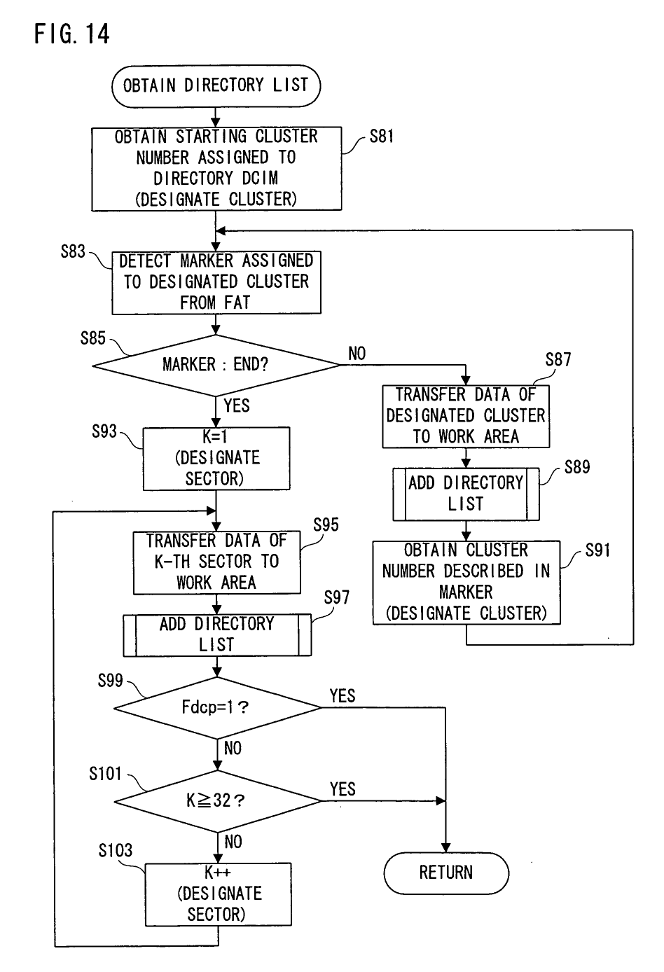

The CPU38 executes in parallel a plurality of tasks including a main task shown in FIG. 10, a shooting task shown in FIG. 11-FIG. 12, and a reproduction task shown in FIG. 13. Furthermore, the CPU38 executes subroutines shown in FIG. 14-FIG. 17 as necessary. In addition, control programs corresponding to these flowcharts are stored in the flash memory 34.

Referring to FIG. 10, an initialization processing is performed in a step S1. Thus, the work area 24c (see FIG. 2) on the SDRAM 24 is cleared. In a step S3, it is determined whether or not the currently selected mode is a camera mode. If YES is here, a shooting task is activated in a step S5, while if NO, a reproduction task is activated in a step S7. After completion of the process in the step S5 or S7, it is determined whether or not a mode switching operation is performed in a step S9. If YES is here, a running task is stopped in a step S11, and the process then returns to the step S3.

Referring to FIG. 11, in a step S21, a directory obtaining processing is executed in order to create a directory list DL on which a plurality of directory names to be managed by the directory “DCIM” are listed on the work area 24c. In a step S23, any one of the directory names listed in the directory list DL is designated. In a succeeding step S25, a file list obtaining processing is executed in order to create the file list FL*(*:1 or 2) on which a plurality of filenames to be managed by the designated directory are listed on the work area 24c.

In a step S27, it is determined whether or not a shooting operation is performed, and if YES, a shooting processing is executed in a step S29. Consequently, the JPEG data corresponding to the object scene at a time the shooting operation is performed is retained in the JPEG area 24b of the SDRAM 24 (see FIG. 2).

In a step S31, it is determined whether or not a novel directory has to be created. More specifically, it is determined whether or not the identification number forming the filename described in the end of the file list FL*reaches “1000”. If “NO” here, it is regarded that the newly created JPEG file can be managed under the currently designated directory, and the process directly proceeds to a step S39. On the contrary thereto, if “YES” in the step S31, it is regarded that the newly created JPEG file cannot be managed under the currently designated directory, and the process proceeds to a step S33.

In the step S33, the new directory is created in the hierarchical sequence below the directory “DCIM”. In FIG. 4 example, the novel directory information is additively written to the DE block in the cluster 2. In a step S35, a directory list obtaining processing is executed again in order to update the directory list DL. In the updated directory list DL, the directory name forming the new directory information is described. In a step S37, the novel directory is designated, and then, the process proceeds to a step S39.

In the step S39, the JPEG file including the JPEG data stored in the JPEG area 24b is recorded in the data area 32b of the recording medium 32. In a step S41, the file information of the JPEG file thus recorded is additively written to the DE block of the designated directory. In a succeeding step S43, the FAT 1 and the FAT 2 are updated such that a link is established between a plurality of clusters to which the JPEG file is written. After completion of the process in the step S43, the process returns to the step S25.

Referring to FIG. 13, in steps S51-S55, the processing similar to that shown in steps S21-S25 in FIG. 11 is executed. Thus, the directory list DL on which the plurality of directory names managed by the directory DCIM are listed and the file list FL*on which the plurality of filenames managed by the directory designated in the step S53 are obtained on the work area 24c.

In a step S57, it is determined whether or not all the directories on the directory list DL are designated. If “NO” here, the directory which has not yet been designated is designated in the step S53, and the process in the step S55 is executed again. Consequently, the file lists FL1 and FL2 respectively shown in FIG. 8 and FIG. 9 are obtained on the work area 24c.

In a step S59, any one of the directories on the directory list DL and any one of the JPEG files on the file list FL * in correspondence thereto are designated. In a step S61, reproduction processing is performed on the designated JPEG file. Consequently, a reproduced image is output form the LCD monitor 28.

When an updating operation is performed, “YES” is determined in a step S65, and the designation of the directory and/or file is updated in a step S71, and then, the process returns to the step S61. Consequently, the reproduced image output from the LCD monitor 28 is updated.

When a delete operation is performed, delete processing is executed in a step S67. Thus, the file information of the JPEG file currently reproduced is deleted from directory in the upper hierarchical sequence, and according to the deletion, the FAT 1 and the FAT 2 are updated. After completion of updating the FAT 1 and the FAT 2, file list obtaining processing is executed again in a step S69, and then, the process returns to the step S59.

The directory list obtaining processing in the step S21 shown in FIG. 11, in the step S35 shown in FIG. 12 or in the step S51 shown in FIG. 13 is executed according to the subroutine shown in FIG. 14. Referring to FIG. 14, in a step S81, a starting cluster number assigned to the directory “DCIM” is obtained on the root directory. In a step S83, a marker assigned to the cluster having the obtained cluster number, that is, the designated cluster is detected from the FAT 1 or the FAT 2. In a step S85, it is determined whether or not the detected marker indicates “end”, that is, whether or not the designated cluster is an end cluster.

If “NO” here, the cluster data stored in the designated cluster is read from the work area 24c of the SDRAM 24. In a step S89, directory list adding processing is executed by noting the read cluster data. The directory name included in the read cluster data is added to the directory list DL by this processing. In a succeeding step S91, a cluster number described in the marker detected in the step S83 is obtained. After completion of the process in the step S91, the process returns to the step S83.

Thus, cluster numbers linked with the cluster number obtained in the step S81 are sequentially detected, and the cluster data stored in the clusters having the detected cluster numbers are sequentially read to the work area 24c. If the designated cluster is an end cluster, “YES” is determined in the step S85, and the process proceeds to a step S93. It should be noted that in the examples shown in FIG. 4 and FIG. 6, “YES” is determined in the process in the step S85 at the first cycle.

In the step S93, a variable K is set to “1” in order to designate the K-th sector forming the end cluster. In a succeeding step S95, the sector data stored in the K-th sector is read to the work area 24c, and in a step S97, directory list adding processing as described above is executed by noting the read sector data.

In a step S99, it is determined whether or not the flag Fdcp is “1”, and in a step S101, it is determined whether or not the variable K is equal to or more than “32”. The flag Fdcp is set to “1” by the directory list adding processing when the end of the directory DCIM is detected. In addition, one cluster is formed by 32 sectors, and therefore, the variable K indicates “32” when the currently noticed sector is an end sector.

If “NO” in both of the steps S99 and S101, the variable K is incremented in order to designate a next sector in a step S103, and then, the process returns to the step S95. If “YES” in the step S99 or S101, the process is returned to the hierarchical upper level of the routine.

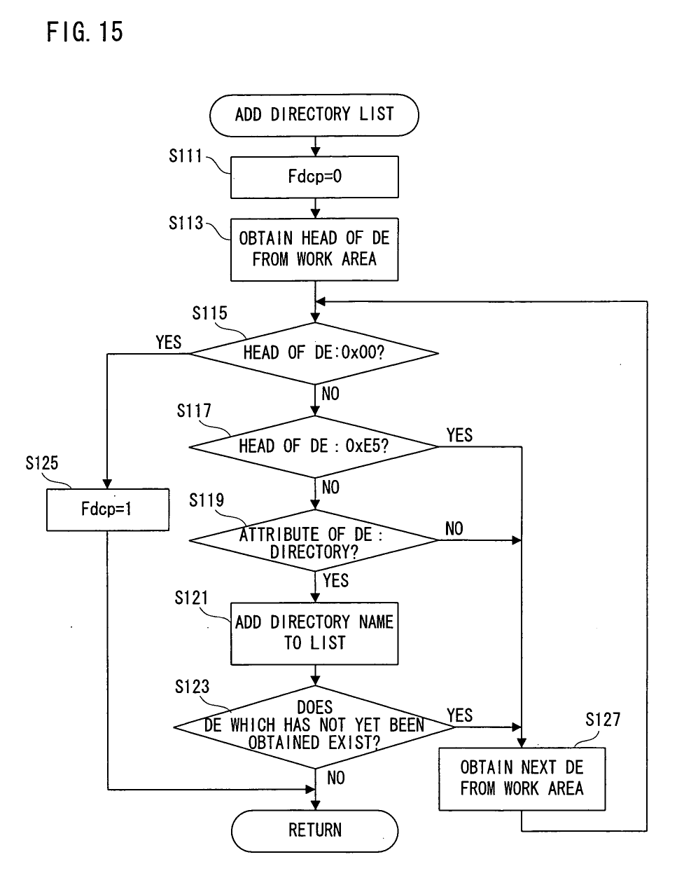

The directory list adding processing in the step S89 or S97 is executed according to the subroutine shown in FIG. 15. First, in a step S111, the flag Fdcp is set to “0”. In a step S113, a first DE (Data Entry) block is obtained from the cluster data or the sector data on the work area 24c.

In a step S115, it is determined whether or not the numerical value described in a head of the noticed DE block is “0x00”, that is, whether or not the noticed DE block and the onward are totally invalid blocks. In a step S117, it is determined whether or not the numerical value described in a head of the noticed DE block is “0xE5”, that is, whether or not only the noticed DE block is an invalid block. In a step S119, it is determined whether or not the attribute described in the noticed DE block is “directory”.

If “YES” in the step S115, it is regarded that the end of the directory DCIM is detected, the flag Fdcp is set to “1” in a step S125, and then, the process is returned to the hierarchical upper level of the routine. If “YES” in the step S117, or if “NO” in the step S119, a next DE block is obtained from the work area 24c in a step S127, and then, the process returns to the step S115.

If “NO” is determined in the step S117, and if “YES” is determined in the step S119, the process proceeds to a step S121, and a directory name described in the obtained DE block is added to the directory list DL. In a step S123, it is determined whether or not the DE block which has not yet been obtained exists, and if “YES”, the process proceeds to a step S127 while if “NO”, the process is returned to the hierarchical upper level of the routine.

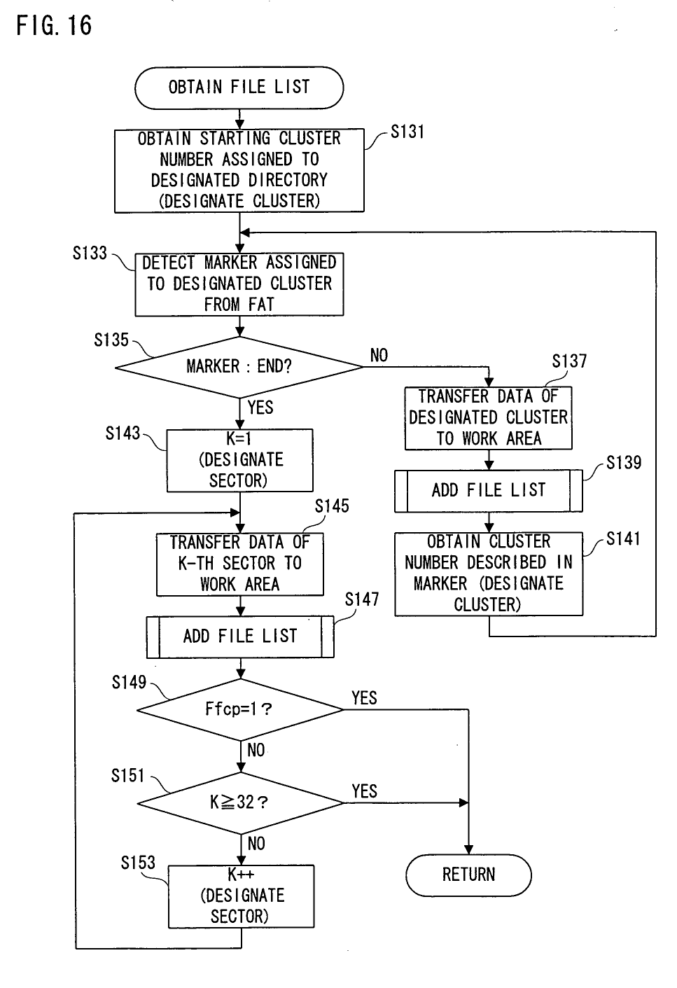

The file list obtaining processing in the step S25 shown in FIG. 11 or the step S55 shown in FIG. 13 is executed according to the subroutine shown in FIG. 16. However, the process in steps S131-S153 shown in FIG. 16 is the same as the process in the steps S81-S103 shown in FIG. 14 except for that the starting cluster number assigned to the designated directory on the directory DCIM is obtained in the step S131, a file list adding processing is executed in the step S139 or the S147, and it is determined whether or not the flag Ffcp is “1” in the step S149. Thus, the redundant description is omitted.

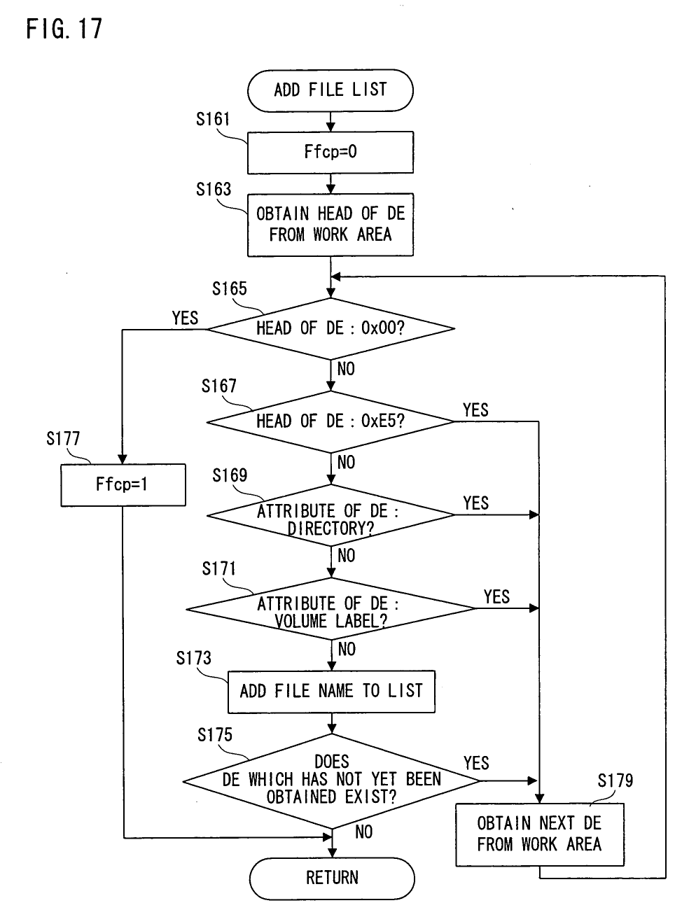

The file list adding processing in the step S139 or S147 is executed according to the subroutine shown in FIG. 17. However, the processing in steps S161-S179 shown in FIG. 17 is the same as the process in the steps S111-S127 shown in FIG. 15 except for that “0” is set to the flag Ffcp in the step S161, “1” is set to the flag Ffcp in the step S171, a filename is added to the file list in the step S173 and the attribute of the DE block is determined in each of the steps S169 and S171, and if the attribute is “directory” or “volume label”, the process proceeds to the step S179 while if the attribute is neither “directory” nor “volume level”, the process proceeds to the step S173. Accordingly, the redundant description is omitted. In addition, the flag Ffcp is set to “1” in the step S177 when the end of the file information is detected.

As understood from the above description, a superior directory (superior item) managing a plurality of subordinate directories (subordinate items) is stored in one or more clusters (first unit areas). The respective clusters are designated in turn in the steps S81 and S91. Each of a plurality of sectors (second unit areas) forming the designated cluster is designated in turn in the steps S93 and S103. Whether or not the designated cluster is an end cluster is determined in the step S85, and whether or not the designated sector is an end sector is determined in the step S101.

The data (superior item data) stored in the designated cluster is read in the step S87 when the determination result in the step S85 is negative. The data (other superior item data) stored in the designated sector is read in the step S95 when the determination result in the step S85 is affirmative, and the determination result in the step S101 is negative. The subordinate directory name included in the read data is added to the directory list DL (subordinate item list) in the step S121.

Thus, if the designated cluster is a cluster prior to the end cluster, the data stored in the cluster is read in the step S87. Since the respective one or more noticed clusters are successively designated in the step S91, the data stored in the clusters prior to the end cluster are successively read in the step S87.

When the designated cluster is the end cluster, and the designated sector is a sector prior to the end sector, the data stored in the sector is read in the step S95. Since each of the plurality of noticed sectors is designated in turn in the step S103 also, the data stored in the sector prior to the end sector is read in turn in the step S95.

That is, data reading is executed for each cluster until the end cluster is detected, and when the end cluster is detected, data reading for each sector is executed. This reduces frequent access operation and prevents useless data reading processing from being performed, capable of shortening a time required to create the directory list DL.

Similarly, the directory (superior item) managing a plurality of JPEG files (subordinate items) is stored in one or more clusters (first unit areas). Each of the clusters is designated in turn in the steps S131 and S141. Each of the plurality of sectors forming the designated cluster is designated in turn in the steps S143 and S153. Whether or not the designated cluster is the end cluster is determined in the step S135, and whether or not the designated sector is the end sector is determined in the step S151.

The data (superior item data) stored in the designated cluster is read in the step S137 when the determination result in the step S135 is negative. The data (superior item data) stored in the designated sector is read in the step S145 when the determination result in the step S135 is affirmative, and the determination result in the step S151 is negative. The filename included in the read data is added to the file list FL1 or FL2 (subordinate item list) in the step S173.

Thus, if the designated cluster is a cluster prior to the end cluster, the data stored in the cluster is read in the step S137. In the step S141, each of one or more noticed clusters is designated in turn, and therefore, in the step S137, the data stored in the clusters prior to the end cluster are read in turn.

If the designated cluster is the end cluster, and if the designated sector is the sector prior to the end sector, the data stored in the sector is read in the step S145. In the step S153, each of one or more noticed clusters is designated in turn, and therefore, in the step S145, the data stored in the clusters prior to the end cluster are read in turn.

That is, the data reading for each cluster is executed until the end cluster is detected, and when the end cluster is detected, the data reading for each sector is executed. This reduces frequent access operation and prevents useless data reading processing from being performed, capable of shortening a time required to create the file list FL1 or FL2.

In this embodiment, a description is made by utilizing a digital camera, but the present invention can be applied to a content recording reproducing apparatus, such as a stationary video recorder, etc. Also, in this embodiment, one cluster is defined as a “first unit area”, and one sector is defined as a “second unit area”. However, two or more preset number of clusters may be defined as a “first unit area”, or two or more preset number of sectors may be defined as a “second unit area”.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A list creating apparatus, comprising:
a first unit area designator for designating in turn each of one or more first unit areas storing a superior item which manages a plurality of subordinate items;
a second unit area designator for designating in turn each of a plurality of second unit areas which forms the first unit area designated by said first unit area designator;
a first unit area determiner for determining whether or not the first unit area designated by said first unit area designator is an end first unit area;
a second unit area determiner for determining whether or not the second unit area designated by said second unit area designator is an end second unit area;
a first reader for reading superior item data from the first unit area designated by said first unit area designator when the determination result by said first unit area determiner is negative;
a second reader for reading another superior item data from the second unit area designated by said second unit area designator when the determination result by said first unit area determiner is affirmative, and the determination result by said second unit area determiner is negative; and
a creator for creating a subordinate item list on the basis of the superior item data read by each of said first reader and said second reader.

2. A list creating apparatus according to claim 1, further comprising:
a detector for detecting an end of said superior item on the basis of the superior item data read by said second reader; and
a finisher for finishing the creating process by said creator in response to the detection of said detector.

3. A list creating apparatus according to claim 1, wherein said first unit areas are discretely distributed on a recording medium and managed by an arrangement management table, and said first unit area determiner performs a determination operation with reference to said arrangement management table.

4. A list creating apparatus according to claim 1, wherein said second unit areas are successive in each first unit area, the number of second unit areas belonging to each first unit area is fixed, and said second unit area determiner performs a determination operation by counting the number of second unit areas designated by said second unit area designator.

5. A list creating apparatus according to claim 1, wherein said first unit area corresponds to a cluster, said second unit area corresponds to a sector, and said item corresponds to a directory or a file.

6. A list creating program executed by a processor of a list creating apparatus, including steps of:
a first unit area designating step for designating in turn each of one or more first unit areas storing a superior item which manages a plurality of subordinate items;
a second unit area designating step for designating in turn each of a plurality of second unit areas which forms the first unit area designated by said first unit area designating step;
a first unit area determining step for determining whether or not the first unit area designated by said first unit area designating step is an end first unit area;
a second unit area determining step for determining whether or not the second unit area designated by said second unit area designating step is an end second unit area;
a first reading step for reading superior item data from the first unit area designated by said first unit area designating step when the determination result by said first unit area determining step is negative;
a second reading step for reading another superior item data from the second unit area designated by said second unit area designating step when the determination result by said first unit area determining step is affirmative, and the determination result by said second unit area determining step is negative; and
a creating step for creating a subordinate item list on the basis of the superior item data read by each of said first reading step and said second reading step.

7. A list creating method, including steps of:
(a) designating in turn each of one or more first unit areas storing a superior item which manages a plurality of subordinate items,
(b) designating in turn each of a plurality of second unit areas which forms the first unit area designated by said step (a),
(c) determining whether or not the first unit area designated by said step (a) is an end first unit area,
(d) determining whether or not the second unit area designated by said step (b) is an end second unit area,
(e) reading superior item data from the first unit area designated by said step (a) when the determination result by said step (c) is negative,
(f) reading another superior item data from the second unit area designated by said step (b) when the determination result by said step (c) is affirmative, and the determination result by step (d) is negative, and
(g) creating an item list on the basis of the superior item data read by each of said step (e) and said step (f).
